(19) United States
(12) Patent Application Publication
(10) Pub. No.: US 2026/0148136 A1
(43) Pub. Date: May 28, 2026

(54) MODEL TRAINING METHOD AND SYSTEM BASED ON FEDERATED LEARNING

(71) Applicant: National Tsing Hua University, Hsinchu (TW)

(72) Inventors: BO-CHEN LIN, Chiayi (TW); Jeng-Lin Li, Hsinchu (TW); Woan-Shiuan Chien, Hsinchu (TW); Chi-Chun Lee, Hsinchu (TW)

(21) Appl. No.: 19/178,469

(22) Filed: Apr. 14, 2025

(30) Foreign Application Priority Data
Nov. 14, 2024 (TW) 113143892

(51) Int. Cl. G06N 20/00

(52) U.S. Cl. CPC G06N 20/00

(57) ABSTRACT

A method for implementing model training, based on federated learning, is provided. The method includes: receiving multiple first model parameter sets correspondingly from multiple devices; calculating at least one first distance between one set of the multiple first model parameter sets corresponding to a first device and at least one other set of the multiple first model parameter sets corresponding to at least one other device, different from the first device; calculating at least one first weight corresponding to the first device based on the at least one first distance; calculating a first weighted average of the multiple first model parameter sets based on the at least one first weight, to obtain a second model parameter set corresponding to the first device; and sending the second model parameter set corresponding to the first device to the first device. In addition, a system using the method is also provided.

### CROSS-REFERENCE TO RELATED APPLICATION(S)

The present application claims the benefit of and priority to Taiwan Patent Application No. 113,143,892, filed on Nov. 14, 2024, the contents of which are hereby fully incorporated herein by reference for all purposes.

### FIELD

The present disclosure is generally related to a machine learning technology and, more specifically, to a method and system for implementing model training based on federated learning.

### BACKGROUND

With the rapid development of artificial intelligence and machine learning, large-scale data training models have become a key method for improving model performance. However, in practical applications, due to data privacy and security concerns, as well as limitations in computing capabilities of various terminal devices, traditional centralized machine learning methods face numerous challenges.

To address this issue, federated learning technology has emerged. Federated learning allows multiple participating parties to mutually train models without sharing raw data, effectively protecting data privacy. However, existing federated learning methods still have certain limitations. For example, most federated learning methods adopt averaging strategies to aggregate model parameters, ignoring the differences in data distribution among different participating parties. Such strategies struggle to handle data heterogeneity issues among participating parties and cannot provide sufficiently personalized models for each participating party.

Moreover, in traditional federated learning, since each participating party can only train with local data, models often fail to effectively learn common data features, thus affecting model performance on new data and overall efficiency.

### SUMMARY

In view of this, the present disclosure provides a method and system for implementing model training based on federated learning, which aims to solve problems in existing federated learning technology, capable of improving model performance in heterogeneous data environments while protecting data privacy of participating parties, effectively enhancing model personalization, learning efficiency, and generalization capability, thus providing an innovative solution to challenges faced by federated learning in practical applications.

A first aspect of the present disclosure provides a method for implementing model training, based on federated learning, applicable to a central server. The method includes: receiving multiple first model parameter sets correspondingly from multiple devices; calculating at least one first distance between one set of the multiple first model parameter sets corresponding to a first device, among the multiple first devices, and at least one other set of the multiple first model parameter sets corresponding to at least one other device, different from the first device, among the multiple devices; calculating at least one first weight corresponding to the first device based on the at least one first distance; calculating a first weighted average of the multiple first model parameter sets based on the at least one first weight, to obtain a second model parameter set corresponding to the first device; and sending the second model parameter set corresponding to the first device to the first device.

In some implementations of the first aspect, the method further includes: calculating at least one second distance between one set of the multiple first model parameter sets corresponding to a second device, among the multiple devices, and at least one other set of the multiple first model parameter sets corresponding to at least one other device, different from the second device, among the multiple devices; calculating at least one second weight corresponding to the second device based on the at least one second distance; calculating a second weighted average of the multiple first model parameter sets, based on the at least one second weight, to obtain a second model parameter set corresponding to the second device; and sending the second model parameter set corresponding to the second device to the second device.

In some implementations of the first aspect, the method further includes: receiving multiple second model parameter sets correspondingly from the multiple devices, the multiple second model parameter sets including one set of the multiple second model parameter sets corresponding to the first device and at least one other set of the multiple second model parameter sets corresponding to the at least one other device, different from the first device, among the multiple devices; calculating at least one second distance between the one set of the multiple second model parameter sets corresponding to the first device and the at least one other set of the multiple second model parameter sets corresponding to the at least one other device, different from the first device, among the multiple devices; calculating at least one second weight corresponding to the first device based on the at least one second distance; calculating a weighted average of the multiple second model parameter sets, based on the at least one second weight, to obtain a third model parameter set corresponding to the first device; and sending the third model parameter set to the first device.

In some implementations of the first aspect, the at least one first distance includes at least one of a Euclidean distance, a cosine similarity, and a Manhattan distance.

In some implementations of the first aspect, calculating the at least one first weight corresponding to the first device based on the at least one first distance includes: calculating at least one reciprocal of the at least one first distance; and normalizing the at least one reciprocal to obtain the at least one first weight.

In some implementations of the first aspect, the at least one first weight is negatively correlated with the at least one first distance.

A second aspect of the present disclosure provides a method for implementing model training, based on federated learning, applicable to a system including multiple devices and a central server, the method includes, in a current round: a first device, among the multiple devices, obtaining, by using first local data to mutually train a first local model and a mutual model, a first local model parameter set and a first mutual model parameter set; and the central server: receiving multiple mutual model parameter sets from the multiple devices, the multiple mutual model parameter sets comprising the first mutual model parameter set, calculating at least one first distance between the first mutual model parameter set corresponding to the first device and at least one set of the multiple mutual model parameter sets corresponding to at least one other device, different from the first device, among the multiple devices, calculating at least one first weight corresponding to the first device based on the at least one first distance, calculating a weighted average of the multiple mutual model parameter sets based on the at least one first weight to update the first mutual model parameter set corresponding to the first device, and sending the first mutual model parameter set that is updated to the first device; and in a next round, the first device using the first local data, the first local model parameter set, and the first mutual model parameter set that is updated to mutually train the first local model and the mutual model.

In some implementations of the second aspect, the method further includes in the current round: a second device, among the multiple devices, obtaining, by using second local data to mutually train a second local model and the mutual model, a second local model parameter set and a second mutual model parameter set; and the central server further: receiving the multiple mutual model parameter sets from the multiple devices, the multiple mutual model parameter sets further including the second mutual model parameter set, calculating at least one second distance between the second mutual model parameter set corresponding to the second device and at least one other set of the multiple mutual model parameter sets corresponding to at least one other device, different from the second device, among the multiple devices, calculating at least one second weight corresponding to the second device based on the at least one second distance, and calculating a weighted average of the multiple mutual model parameter sets based on the at least one second weight to update the second mutual model parameter set corresponding to the second device; and the central server sending the second mutual model parameter set corresponding to the second device; and in the next round, the second device using the second local data, the second local model parameter set, and the second mutual model parameter set that is updated to mutually train the second local model and the mutual model.

In some implementations of the second aspect, the first device, among the multiple devices, using the first local data to mutually train the first local model and the mutual model includes: calculating a difference measure between the first local model and the mutual model; and updating the first local model and the mutual model based on the difference measure.

A third aspect of the present disclosure provides a central server, which includes: a memory, configured for storing at least one instruction; and a processor, coupled to the memory, where when the processor executes the at least one instruction, the central server is configured to: receive multiple first model parameter sets correspondingly from multiple devices; calculate at least one first distance between one set of the multiple first model parameter sets corresponding to a first device, among the multiple devices, and at least one other set of the multiple first model parameter sets corresponding to at least one other device, different from the first device, among the multiple devices; calculate at least one first weight corresponding to the first device based on the at least one first distance; calculate a first weighted average of the multiple first model parameter sets, based on the at least one first weight, to obtain a second model parameter set corresponding to the first device; and send the second model parameter set corresponding to the first device to the first device.

In some implementations of the third aspect, when the processor executes the at least one instruction, the central server is further configured to: calculate at least one second distance between one set of the multiple first model parameter sets corresponding to a second device, among the multiple devices, and at least one other set of the multiple first model parameter sets corresponding to at least one other device, different from the second device, among the multiple devices; calculate at least one second weight corresponding to the second device based on the at least one second distance; calculate a second weighted average of the multiple first model parameter sets, based on the at least one second weight, to obtain a second model parameter set corresponding to the second device; and send the second model parameter set corresponding to the second device to the second device.

In some implementations of the third aspect, when the processor executes the at least one instruction, the central server is further configured to: receive multiple second model parameter sets correspondingly from the multiple devices, the multiple second model parameter sets including one set of the multiple second model parameter sets corresponding to the first device and at least one other set of the multiple second model parameter sets corresponding to the at least one other device, different from the first device, among the multiple devices; calculate at least one second distance between the one set of the multiple second model parameter sets corresponding to the first device and the at least one other set of the multiple second model parameter sets corresponding to the at least one other device, different from the first device, among the multiple devices; calculate at least one second weight corresponding to the first device based on the at least one second distance; calculate a weighted average of the multiple second model parameter sets, based on the at least one second weight, to obtain a third model parameter set corresponding to the first device; and send the third model parameter set to the first device.

In some implementations of the third aspect, the at least one first distance includes at least one of a Euclidean distance, a cosine similarity, and a Manhattan distance.

In some implementations of the third aspect, calculating the at least one first weight corresponding to the first device based on the at least one first distance includes: calculating at least one reciprocal of the at least one first distance; and normalizing the at least one reciprocal to obtain the at least one first weight.

In some implementations of the third aspect, the at least one first weight is negatively correlated with the at least one first distance.

### BRIEF DESCRIPTION OF THE DRAWINGS

FIG. 1 is a diagram of a model training method in accordance with an example implementation of the present disclosure.

FIG. 2 is a flowchart of a model training method in accordance with an example implementation of the present disclosure.

FIG. 3 is a diagram of a model training method in accordance with an example implementation of the present disclosure.

FIG. 4 is a flowchart of a model training method in accordance with an example implementation of the present disclosure.

FIG. 5 is a block diagram of a computing system in accordance with an example implementation of the present disclosure

### DESCRIPTION

The following will refer to the relevant drawings to describe implementations of a model training method and system based on federated learning in the present disclosure, in which the same components will be identified by the same reference symbols.

The following description includes specific information regarding the exemplary implementations of the present disclosure. The accompanying detailed description and drawings of the present disclosure are intended to illustrate the exemplary implementations only. However, the present disclosure is not limited to these exemplary implementations. Those skilled in the art will appreciate that various modifications and alternative implementations of the present disclosure are possible. In addition, the drawings and examples in the present disclosure are generally not drawn to scale and do not correspond to actual relative sizes.

For consistency and ease of understanding, the same features are denoted by numerals in the exemplary drawings (although not always marked as such in some examples). However, features in different implementations may differ in other respects, and should not be narrowly confined to the features shown in the drawings.

Terms such as “at least one implementation,” “one implementation,” “various implementations,” “different implementations,” “some implementations,” “this implementation,” may indicate that the implementation(s) described as such may include specific features, structures, or characteristics, but not all possible implementations of the present disclosure need to include these specific features, structures, or characteristics. Moreover, the repeated use of the phrases “in one implementation,” “in this implementation” does not necessarily refer to the same implementation, although they may be. Furthermore, phrases like “implementation” used in conjunction with “the present disclosure” do not imply that all implementations must include specific features, structures, or characteristics, and should be understood to mean “at least some implementations of the present disclosure” include the specified features, structures, or characteristics. The term “coupled” is defined as a connection, whether direct or indirect, through an intermediate component, and is not necessarily limited to a physical connection. When the terms “comprising” or “including” are used, they mean “including but not limited to,” and explicitly indicate an open relationship between the combination, group, series, and the like.

Additionally, for the purpose of explanation and non-limitation, specific details such as functional entities, techniques, protocols, standards, etc., are set forth to provide an understanding of the described technology. In other examples, detailed descriptions of well-known methods, techniques, systems, architectures, etc., have been omitted to avoid unnecessarily obscuring the described implementations.

The terms “first,” “second,” and “third” and the like are used to distinguish different objects, not to describe a specific order. Furthermore, the terms “comprising” and any variations thereof are intended to cover non-exclusive inclusion. For example, a process, method, system, product, or device that includes a series of steps or modules is not limited to the listed steps or modules, but may optionally include unlisted steps or modules, or other steps or modules inherent to these processes, methods, products, or devices.

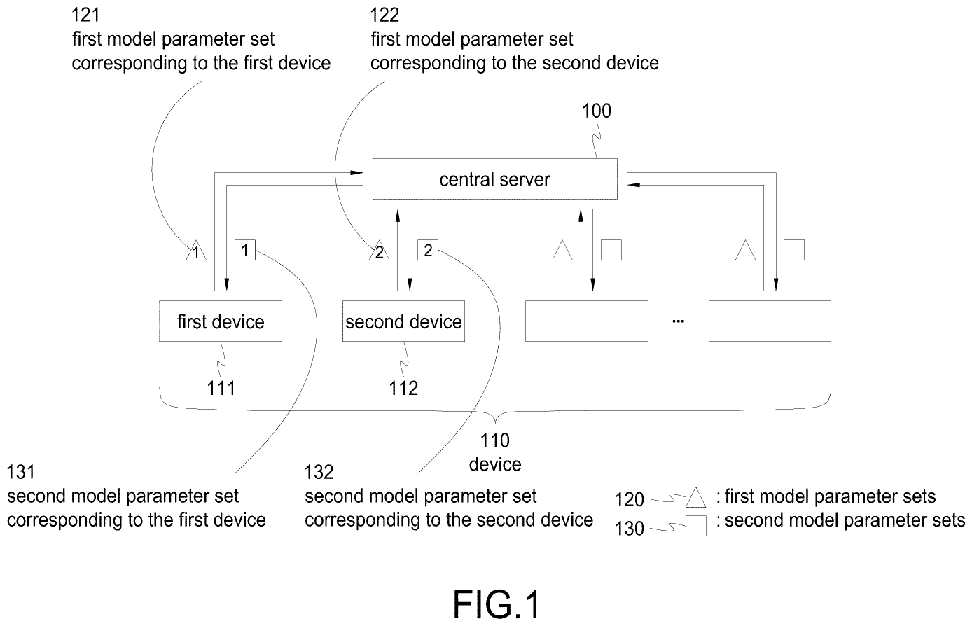

FIG. 1 is a diagram of a model training method in accordance with an example implementation of the present disclosure.

Referring to FIG. 1, the system for training models may include a central server 100 and multiple devices 110. For clarity, within the numerous devices 110, a first device 111 and a second device 112 are identified. However, it should be noted that the first device 111 and the second device 112 are merely representative examples used to illustrate the implementations of the present disclosure, and they may be functionally identical to other devices 110. The method of model training, based on federated learning, provided in this implementation may be applicable to an architecture including at least two devices 110. Although multiple devices 110 are shown in FIG. 1, the method may be equally applicable to configurations with only two devices 110 participating.

The model training in a federated learning process may be divided into two main stages: local model training and mutual model training. Specifically, the local model training stage may refer to each participating device 110 training the model using its local data. The training process may be conducted entirely on the device 110 side without transmitting raw data to the central server 100, thus protecting data privacy. The mutual model training stage, on the other hand, may be coordinated by the central server 100, which may integrate the model information of all participating devices 110 to generate a mutual model that represents the collective learning achievements of the system. These two stages may work closely together, alternating with each other. The devices 110 may conduct local model training and then transmit model parameters to the central server 100, the central server 100 then may perform mutual model training with the received model parameters before sending updated model parameters back to each device, and so on, ultimately producing a high-performance model that utilizes distributed data while protecting privacy.

Specifically, the central server 100 may coordinate the entire federated learning process, including receiving model parameters from each device 110, performing necessary calculations, and sending updated model parameters back to each device 110. For example, the central server 100 may be a high-performance computing system with strong processing capabilities and substantial storage space.

In some implementations, the central server 100 may be a cloud server to provide greater scalability and reliability. Advantageously, such a configuration may enable the central server 100 to effectively execute the model training methods of the present disclosure and coordinate a large-scale federated learning process.

Specifically, the device 110 may be a terminal with sufficient computing power capable of performing the local model training methods provided in the implementation, such as smartphones, smart watches, laptops, IoT devices, and the like. The present disclosure is not limited thereto. In some implementations, device 110 may also be an edge computing device or a small server. It should be noted that this implementation allows the participation of heterogeneous devices 110, meaning the system may include devices with different hardware specifications, computing power, storage capacities, operating systems, etc. For example, the system may include both smartphones and sensors, or devices 110 running different operating systems. Advantageously, the method provided in the implementation of the present disclosure may adapt to these differences between devices 110, allowing different types of devices to effectively participate in federated learning, effectively expanding the scope of application.

Specifically, the central server 100 may receive a first model parameter set 120 transmitted from each device 110. Associated with the first device 111 is a first model parameter set 121 corresponding to the first device 111, and associated with the second device 112 is the other first model parameter set 122 corresponding to the second device 112, and so forth. These first model parameter sets 120 may reflect the initial model state of each device 110 for performing the local model training. This transmission method only transmits model parameters to the central server 100 rather than raw data, effectively protecting user privacy.

Specifically, upon receiving these first model parameter sets 120, the central server 100 may perform a series of mutual model training, the details of which will be further explained later. After training, the central server 100 may generate multiple second model parameter sets 130 and send these second model parameter sets 130 back to the respective devices 110. Associated with the first device 111 is the second model parameter set 131 corresponding to the first device 111, and associated with the second device 112 is the second model parameter set 132 corresponding to the second device 112, and so forth. These second model parameter sets 130 may represent the updated model states after training by the central server 100. Similarly, the central server 100 may subsequently receive a second model parameter set 130 sent from each device 110. After receiving these second model parameter sets 130, the central server 100 may perform a new round of mutual model training. After training, the central server 100 may generate multiple third model parameter sets and send these third model parameter sets back to the respective devices 110. In other words, in the t-th round of training (where t is a positive integer), after the central server 100 receives these t-th model parameter sets of t-th round, the central server 100 may conduct a series of mutual model training. After the t-th round of training, the central server 100 may generate multiple (t+1)-th model parameter sets of (t+1)-th round and send these (t+1)-th model parameter sets back to the respective devices 110. This process embodies the iterative updating of model parameters. These t-th model parameter sets of t-th round are the parameters uploaded by the devices 110 after the t-th round of local model training, while the (t+1)-th model parameter sets of (t+1)-th round are the updated parameters obtained by the central server 100 based on these parameters after mutual model training. These updated parameters may be sent back to the respective devices 110 for the next round (i.e., the (t+1)-th round) of local model training.

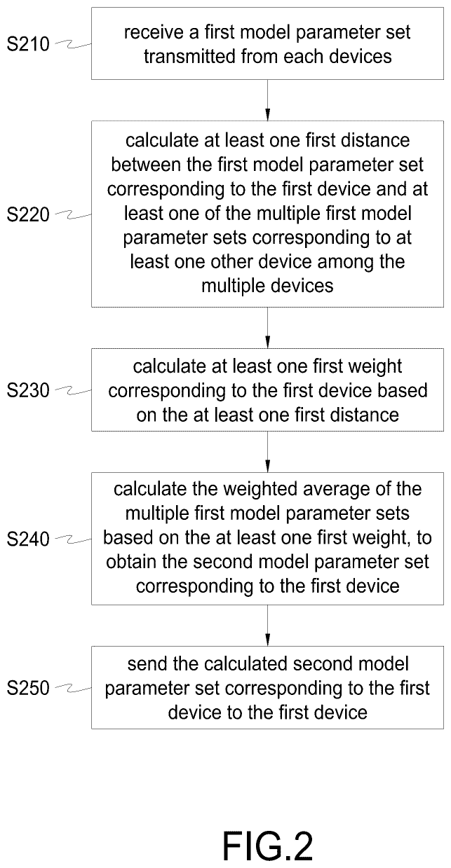

FIG. 2 is a flowchart of a model training method in accordance with an example implementation of the present disclosure.

Referring to FIG. 2, the central server 100 may processes model parameters from the multiple devices 110 and may generate updated model parameters. In step S210, the central server 100 may receive a first model parameter set 120 transmitted from each devices 110, these first model parameter sets 120 may reflect the initial model state of each device 110 for performing the local model training.

Specifically, the first model parameter sets 120 may include parameters that reflect the model state of each device 110. In some implementations, these parameters may be represented in the form of vectors or matrices. It should be noted that, since the devices 110 may encounter different local data, their first model parameter sets 120 may vary. The central server 100, by comparing and integrating these parameters, may achieve personalization and global optimization of the model while protecting data privacy.

In some implementations, the first model parameter sets 120 may also include other model-related information, such as model architecture descriptions, hyperparameter settings, and the like. This additional information may help the central server 100 to more comprehensively understand and process the model states of the devices 110.

In step S220, the central server 100 may calculate at least one first distance between the first model parameter set 121 corresponding to the first device 111 and at least one of the multiple first model parameter sets 120 corresponding to at least one other device among the multiple devices 110. This step may aim to quantify the degree of difference between models of different devices. Specifically, “distance” here may refer to a mathematical measure that quantifies the differences between two model parameter sets.

In some implementations, the Euclidean distance may be used to calculate the distance between model parameters as a measure of distance. The Euclidean distance is a method used in multidimensional space to measure the straight-line distance between two points. Advantageously, using the Euclidean distance may intuitively reflect the degree of difference between model parameters, and may be relatively simple to calculate and applicable in various situations. Choosing the Euclidean distance as a method of distance measurement may help maintain computational efficiency while accurately quantifying the differences in model parameters between different devices 110.

In some implementations, variants of cosine similarity may be used to measure the degree of difference between model parameters, thus serving as a basis for distance measurement. The cosine similarity may measure the similarity in direction between two vectors. It should be noted that the cosine similarity may be negatively correlated with the intuitive concept of distance, i.e., the higher the similarity, the smaller the corresponding concept of distance. Therefore, in the implementations of the present disclosure, we may use a transformed form of the cosine similarity, such as using the reciprocal of the cosine similarity as a distance measure. This transformation may ensure that the metric has the properties of distance, where larger values indicate greater differences. Advantageously, using a distance measure based on the cosine similarity may effectively capture directional differences in model parameters, and may be particularly suitable for comparing high-dimensional data. This method may not be affected by the absolute size of vectors, hence it may have advantages in handling model parameters of varying scales. For example, this method may still provide consistent and meaningful comparison results even when the devices 110 may have different parameter scales. Additionally, calculations based on the cosine similarity may be relatively simple and computationally efficient, which may be an important advantage in large-scale federated learning systems, as it may reduce computational costs and speed up model updates.

In some implementations, the Manhattan distance may be used as a distance measure between model parameters. The Manhattan distance, also known as city block distance, may measure the distance between two points in a Cartesian coordinate system by summing the absolute values of the differences in each dimension. Advantageously, the calculation of the Manhattan distance may be efficient, may be suitable for handling high-dimensional data, and may be less sensitive to outliers, providing a stable distance estimate even in the presence of extreme values. Furthermore, the linear characteristics of the Manhattan distance may enable it to effectively reflect the actual differences between model parameters. For example, when each dimension of the model parameters has independent significance, the Manhattan distance may provide an intuitive and meaningful measure of difference, maintaining computational efficiency while accurately quantifying the differences in model parameters between different devices 110.

It should be noted that the implementations of the present disclosure may not be limited to the aforementioned methods of calculating distance. In practical applications, an appropriate distance measurement method may be chosen based on specific needs, or multiple distance measurement methods may be combined. Those skilled in the art will recognize that changes in form and detail may be made without departing from the scope of these concepts.

To facilitate understanding, this application may refer to the distance between model parameters as the distance between devices 110, as each device 110's model parameters may be considered as the state of that device 110 in the federated learning process. Therefore, those skilled in the art should understand that when discussing the distance between the devices 110 in this application, it may actually refer to the distance between the model parameters of the devices 110. This manner of expression may make the description clearer and may more intuitively reflect the relative positions of the devices 110 in the model space. Specifically, we may use indices i and j to represent different devices, where i and j may be integers ranging from 1 to K, and d(i, j) may represent the distance between device i and device j.

In some implementations, the central server 100 may calculate the distance between each device 110 and other devices 110, excluding the distance between a device 110 and itself, as the distance between a device 110 and itself is meaningless. For example, if there are K devices 110 in the system, where K may be a natural number no less than 2, for the first device 111, the central server 100 may calculate the distances between the first device 111 and the other K−1 devices 110, that is, d(1,2), d(1,3), and so on up to d(1,K). This method may effectively reduce the computational load. In this case, the central server 100 may calculate (K−1)*(K−1) distance values, meaning that for each device 110, the central server 100 may calculate K−1 distance values, forming a distance set that excludes distances to itself.

In some implementations, if there are K devices 110 in the system, where K may be a natural number no less than 2, then the central server 100 may obtain K*K distance values, forming a complete distance matrix. This matrix may include the distance between each one of the devices 110 and all devices 110 (including cases where i=j). For example, in this case, for the first device 111, the central server 100 may calculate d(1,1), d(1,2), and so on up to d(1,K). When the distances between the device 110 may include distances to themselves (i.e., including cases where i=j), the distance between a device 110 and itself may be zero. The purpose of the distance calculation between the devices 110, that is, whether or not the distance between a device 110 and itself is included, may be to quantify the degree of difference in model parameters between different devices 110 to provide a basis for subsequent model training. Advantageously, the method including their own distance may have its application value in certain mathematical models, where the method excluding their own distance may have advantages in reducing computational load.

In some implementations, when K=2, then the central server 100 may calculate: the distance between the first device 111 and the second device 112, and the distance between the second device 112 and the first device 111.

In some implementations, when K=2, then the central server 100 may calculate: the distance between the first device 111 and the first device 111, the distance between the first device 111 and the second device 112, the distance between the second device 112 and the second device 112, and the distance between the second device 112 and the first device 111. As mentioned above, in this case, the distance between the first device 111 and the first device 111 and the distance between the second device 112 and the second device 112 may both be zero.

Returning to step S220, after the above introduction, those skilled in the art should understand that the term “first distance” refers to the distance between the first device 111 and all other devices 110. It should be noted that the method provided in the implementations of the present disclosure also includes calculating at least one second distance between the first model parameter set 122 corresponding to the second device 112 and at least one of the first model parameter sets 120 corresponding to at least one other device 110. That is, the central server 100 performs distance calculations between each participating device 110 and all other devices 110.

In step S230, the central server 100 may calculate at least one first weight corresponding to the first device 111 based on the calculated at least one first distance. This step may transform the distance between models into weights, enabling the personalization of models as provided in the implementations of the present disclosure.

In some implementations, the weight calculation process may be more precisely represented mathematically. If there are K devices 110 in the system, denoted by i, j∈{1, 2, . . . , K} for different devices 110. For device i, the distance to device j may be denoted as d(i,j). The corresponding weight w(i,j) for device i can be calculated as follows:

$${w}_{i , j} = \frac{1 / {d}_{i , j}}{{\sum }_{{k ∈ K}_{k \neq i}} 1 / {d}_{i , j}} , if j \neq i else 0$$

where the weight may be inversely proportional to the distance, that is, the smaller the distance, the greater the weight; secondly, it may be normalized by dividing by the sum of the reciprocals of all distances, ensuring that the sum of all weights except for its own may be 1; finally, when i=j, that is, calculating the weight for the device itself, the weight may be set to 0, ensuring that the device may not directly use its old model parameters during the model update process. Advantageously, this method of weight calculation may not only effectively transform the distances between models into weights during the aggregation process but also may ensure the comparability of weights through normalization. Additionally, the practice of setting its own weights to zero may help to facilitate model updating and improvement, avoiding the problem of over-reliance on its own old parameters.

Specifically, the calculation of weights may be negatively correlated with distance, meaning that the greater the weight between devices 110 with smaller distances, and conversely, the smaller the weight between the devices 110 with greater distances. It should be noted that when the central server 100 calculates the distances between a device 110 and itself (i.e., i=j), the corresponding weight in the weight calculation may be set to 0. This step advantageously may ensure that the old model parameters of the device itself are not considered during model updates. This comprehensive distance calculation method may fully reflect the distribution of models across the entire system, providing a comprehensive basis for subsequent weight calculation and model aggregation. Therefore, for the first device 111, each other device 110 may correspond to a weight w(1,j), and the weight w(1,1) corresponding to the first device 111 itself may be omitted or set to 0; similarly, for the second device 112, each other device 110 may correspond to a weight w(2,j), and the weight w(2,2) corresponding to the second device 112 itself may be omitted or set to 0, and so on.

In some implementations, the weight calculation process may involve the calculation of reciprocals of distances. After the central server 100 calculates the distances between the device 110, it may take the reciprocal of these distance values as the initial weight values, directly reflecting the negative correlation between distance and weight.

In some implementations, the calculated weights may be normalized to ensure that the sum of all weights equals 1, facilitating subsequent weighted average operations. For example, the central server 100 may divide each distance's reciprocal as the initial weight value by the sum of all initial weight values. Advantageously, the weight calculation method based on distance reciprocals and normalization may consider the similarity between the device, ensuring the rationality and effectiveness of weight distribution.

Returning to step S230, the method provided in the implementations of the present disclosure may also include calculating at least one second weight corresponding to the second device 112 based on the calculated at least one second distance. That is, the central server 100 may calculate weights corresponding to each participating device 110. For example, the at least one K-th weight corresponding to the K-th device 110 may be calculated based on the calculated at least one K-th distance, where K may be the total number of devices 110 participating in federal learning.

In step S240, the central server 100 may calculate the weighted average of the multiple first model parameter sets 120 based on the calculated at least one first weight, to obtain the second model parameter set 131 corresponding to the first device 111. Advantageously, the weighted average process may integrate model information from different devices while also considering the impact of personalized weights.

Specifically, taking the first device 111 as an example, after the central server 100 receives the first model parameter set 121 uploaded by the first device 111, it may first calculates the distances between the first device 111 and all the devices 110 (in the case of including the first device 111, for example) and may calculate the corresponding weights based on the distances; then, the central server 100 may multiply the weights of the first device 111 and all the devices 110 by the first model parameter set 120 of the corresponding devices 110; finally, these multiplications may be added together to obtain the second model parameter set 120 corresponding to the first device 111. The method provided in the implementations of the present disclosure may also include, after the central server 100 receives the first model parameter set 122 uploaded by the second device 112, calculating the distances between the second device 112 and all other devices 110, calculating the corresponding weights based on these distances, then multiplying these weights by the respective first model parameter sets 120 of the devices 110, and finally adding these products together to obtain the second model parameter set 132 corresponding to the second device 112. That is, the central server 100 may perform a similar process for each participating device 110, executing the following steps for each device 110 in the system: first calculating the distances between the device 110 and all other devices 110 (including itself, if applicable), then calculating weights based on these distances, subsequently multiplying these weights with all the devices 110's first model parameter sets 120, and finally adding the products to obtain the second model parameter set 130 corresponding to that device 110.

For example, if there are K devices 110 in the system, where K may be a natural number not less than 2, after the central server 100 calculates the weights between the first device 111 and each device 110, the central server 100 may multiply the weight (in this case, the weight may be 0) between the first device 111 and the first device 111 by the first model parameter set 121 corresponding to the first device, obtaining product one. The central server 100 then may multiply the weight between the first device 111 and the second device 112 by the first model parameter set 122 corresponding to the second device, obtaining product two, and so forth. Subsequently, the central server 100 may multiply the weight between the first device 111 and the K-th device by the first model parameter set 120 corresponding to the K-th device, obtaining product K. Finally, the central server 100 may add products one, two, up to K to obtain the second model parameter set 131 corresponding to the first device.

It should be noted that the method provided in the implementations of the present disclosure may also include calculating at least one second weight corresponding to the second device 112 based on the calculated at least one second distance. That is, the central server 100 may calculate weights corresponding to each participating device 110. For example, based on the calculated at least one K-th distance, it may calculate at least one K-th weight corresponding to the K-th device 110, where K may be the total number of devices 110 participating in federated learning.

Those skilled in the art should understand from the above description that, as the weights may be normalized, the method provided in the implementations of the present disclosure may ensure that the greater the distance between the first device 111 and any device 110, the smaller the influence of that device 110's first model parameter set 120 on the second model parameter set 121 corresponding to the first device 111. Conversely, the smaller the distance between the first device 111 and any device 110, the greater the influence of that device 110's first model parameter set 120 on the second model parameter set 121 corresponding to the first device 111. Advantageously, through distance calculations and weight distribution, each device 110 may obtain a model more suited to its own characteristics, enhancing the personalization of the model. Furthermore, by utilizing the learning outcomes of all the devices 110, the optimization process of the model may be accelerated, enhancing learning efficiency. Finally, by integrating the model information from all devices 110, the model's ability to handle different situations may be enhanced, improving its generalizability.

In step S250, the central server 100 may send the calculated second model parameter set 131 corresponding to the first device 111 to the first device 111. It is noteworthy that the central server 100 may perform the same process for each participating device 110 to complete a round of model updates, in order to achieve optimization of the model across the entire system. That is, the central server 100 may also send the calculated second model parameter set 132 corresponding to the second device 112 to the second device 112, and so on until the calculated second model parameter set 130 corresponding to the K-th device 110 may be sent to the K-th device 110, thus completing a round of model updates, which may be the mutual model training mentioned above. This method may not only ensure continuous improvement of the model but also may maintain system consistency and retain the characteristics of each device 110.

For example, after the first device 111 receives the second model parameter set 131 corresponding to the first device, it may use it for the next round of local model training. Since the second model parameter set 131 may be calculated by the central server 100 with distances and weights allocated among other devices 110, incorporating the learning outcomes of the entire system, this process may benefit the overall performance of the model. That is, using the second model parameter set 131 for the next round of training may allow the first device 111 to maintain its characteristics while also benefiting from the data of other devices 110, thus protecting data privacy and achieving effective information sharing. Similarly, other devices (e.g., the second device 112) receiving the corresponding second model parameter set 130 for subsequent actions may also benefit similarly. In some implementations, the second model parameter set 130 in the next round of local model training may replace the first model parameter set, which may quickly integrate global knowledge into the local model, accelerating the convergence of the model. In some implementations, the second model parameter set 130 in the next round of local model training may be introduced as an additional input into the training process, retaining the original local knowledge while introducing global information, better balancing local characteristics with global consistency. Details on the next round of local model training will be explained later.

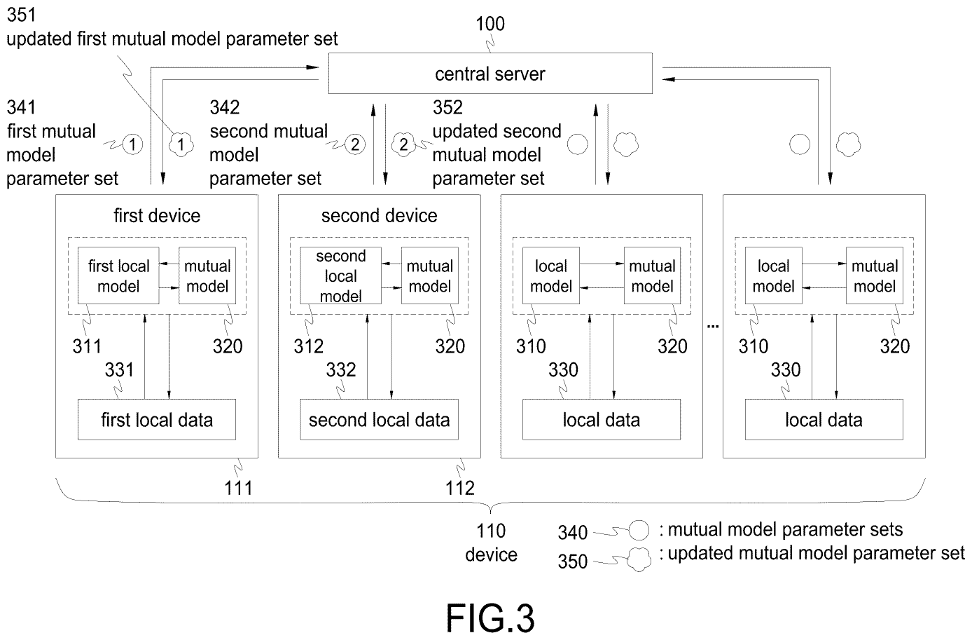

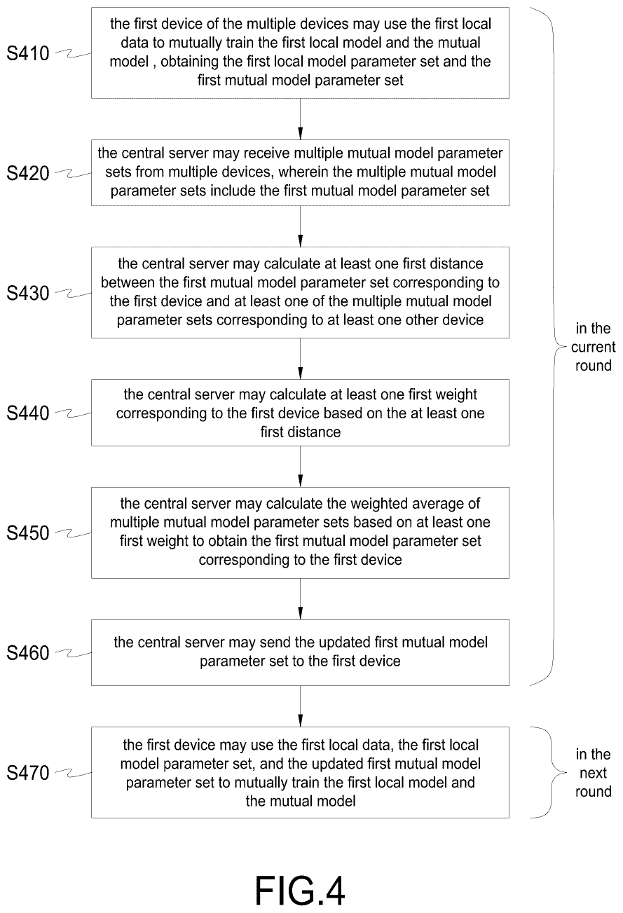

FIG. 3 is a diagram of a model training method in accordance with an example implementation of the present disclosure; FIG. 4 is a flowchart of a model training method in accordance with an example implementation of the present disclosure.

Referring to FIGS. 3 and 4, the system in this implementation may include the central server 100 and multiple devices 110. It should be noted that, for case of explanation, among the many devices 110, the first device 111 and the second device 112 are identified, however, the first device 111 and the second device 112 may not be fundamentally different from other devices 110; they may be merely representative examples used to illustrate the operation of the implementations of the present disclosure.

It is worth noting that the model training method in the implementations of the present disclosure may be an iterative process, where each round of model training may include two phases: local model training (local learning) and mutual model training (mutual learning). The local model may represent a model optimized for local data that may be unique to each device 110, better capturing the data distribution and characteristics of the device 110, while the mutual model may capture common features and patterns across devices, helping to enhance the generalizability of the entire system. This iterative process may gradually optimizes the model to adapt to the data characteristics of different devices 110, with local model training introduced in step S410.

For example, in a health monitoring system, the local model may focus more on the specific health conditions, lifestyle habits, and personal traits of a particular user. For example, for a user who exercises frequently, the local model may be more sensitive to capturing health indicator changes related to physical activity. Meanwhile, the mutual model may capture more general health trends and patterns, such as general health characteristics of people in different age groups, or common correlations between certain health indicators.

In step S410, in the current round, the first device 111 of the multiple devices 110 may use the first local data 331 to mutually train the first local model 311 and the mutual model 320, obtaining the first local model parameter set and the first mutual model parameter set 341. Specifically, the local data 330 may be data held by each device 110, stored locally, which often may contain sensitive personal information, such as medical records, financial data, and the like, that may not be casually shared or transmitted.

Specifically, the mutual training process may involve collaborative learning between the local model 310 and the mutual model 320, aimed at simultaneously enhancing the performance of both models. This process may include prediction, loss function calculation, and model updates. In the context of federated learning, mutual training particularly may emphasize how to effectively use local data to improve model performance while protecting data privacy.

In some implementations, the mutual training process performed by each device 110 may involve training both the local model 310 and the mutual model 320. Specifically, this process may use local data 330 to make predictions through both the local model 310 and the mutual model 320, obtaining outputs from both models, where the prediction may be the process by which the model generates outputs based on the input local data 330, usually being an estimation or guess related to a specific task.

In some implementations, the mutual training process may employ different loss functions to train the local model 310 and the mutual model 320. The loss function may be a metric that measures the discrepancy between the model's prediction results and the actual results, using the Kullback-Leibler divergence to calculate this discrepancy measure. Specifically, these loss functions may include two parts: one part may measure the discrepancy between the model's prediction results and the actual results, and the other part may measure the discrepancy between the outputs of the two models. For example, for the local model 310, its loss function may be:

$${L}_{loc} = α {L}_{{c}_{loc}} + ( 1 - α ) {D}_{KL} ( {p}_{mut} ‖ {p}_{loc} )$$

where L_{c}_{_{loc}} may be the loss term measuring the discrepancy between the local model's prediction results and the actual results, D_{KL} may be the KL divergence, α may be a weight coefficient, pₘᵤₜ and p_{loc} may represent the outputs of the mutual model 320 and the local model 310, respectively.

In some implementations, the mutual model 320 may use a similar but not identical loss function. For example, for the mutual model 320, its loss function may be:

$${L}_{mut} = β {L}_{{c}_{mut}} + ( 1 - β ) {D}_{KL} ( {p}_{loc} ‖ {p}_{mut} )$$

where L_{c}_{ₘᵤₜ} may be the loss term measuring the discrepancy between the mutual model's prediction results and the actual results, β may be another weight coefficient.

In some implementations, the mutual training process may include multiple iterations of training steps. Specifically, in each training iteration, the device 110 may separately calculate and minimize the loss functions of the local model 310 and the mutual model 320. Through appropriate optimization methods (such as backpropagation, though the present disclosure is not limited to this), the parameters of both models may be updated. This process may repeat for a predetermined number of training rounds or until a certain stopping condition is met (such as when the loss function value may fall below a specified threshold). Advantageously, by minimizing the losses (L_{c}_{_{loc}}, and L_{c}_{ₘᵤₜ}), the predictive accuracy of the models may be enhanced; by minimizing the KL divergence, knowledge exchange between models may be facilitated.

This means that in step S410, the first device 111 may use the first local data 331 to perform predictions, calculate loss functions, and compute discrepancy measures through both the first local model 311 and the mutual model 320, subsequently obtaining the first local model parameter set and the first mutual model parameter set 341. Advantageously, this mutual training method may not only consider the accuracy of model predictions relative to real labels but also the consistency between the local and mutual models, maintaining model individuality while also keeping the entire system coordinated, achieving effective knowledge sharing. This method may help to address data heterogeneity issues and simultaneously enhances the overall model performance and adaptability, suitable for decentralized learning environments with varying data distributions. Accordingly, those skilled in the art should understand that the second device 112 may use the second local data 332 to perform predictions, calculate loss functions, and compute discrepancy measures through both the second local model 312 and the mutual model 320, obtaining the second local model parameter set and the second mutual model parameter set 342, and this may be extrapolated to the K-th device. This process ultimately may update all local model parameter sets of the devices 110 (e.g., forming updated local model parameter sets) and mutual model parameter sets 340 (e.g., forming updated mutual model parameter sets 350).

In step S420, the central server 100 may receive multiple mutual model parameter sets 340 from multiple devices 110, including the first mutual model parameter set 341. It should be noted that, although the mutual model parameter sets 340 may originate from the mutual training of the local model 310 and the mutual model 320, they may not contain direct information from the local model 310. This design may protect the privacy of local data and models while allowing the sharing and integration of global knowledge. Through this method, the present disclosure may achieve a balance between privacy protection and model performance, a feat difficult to accomplish with traditional centralized learning methods.

In some implementations, the mutual model parameter sets 340 may also include additional model-related information, such as model architecture descriptions, hyperparameter settings, and the like. This additional information may help the central server 100 more comprehensively understand and process the model states of the devices.

In step S430, the central server 100 may calculate at least one first distance between the first mutual model parameter set 341 corresponding to the first device 111 of the multiple devices 110 and at least one of the multiple mutual model parameter sets 340 corresponding to at least one other device. This step may aim to quantify the degree of difference between models across different devices. Specifically, “distance” here may refer to a mathematical measure of the differences between two model parameter sets. In the implementations of the present disclosure, various methods of distance calculation may be used. It should be noted that the concept of distance calculation introduced in FIG. 4 may be the same as in FIG. 2; the purpose of distance calculations may be to quantify the differences in model parameters between different devices 110, providing a basis for subsequent model training, which is not further elaborated here.

Returning to step S430, after the introduction in FIG. 2, the term “first distance” may refer to the distance between the model parameters of the first device 111 and those of all other devices 110. The method provided in the implementations of the present disclosure may also include calculating at least one second distance between the second mutual model parameter set 342 corresponding to the second device 112 and at least one of the mutual model parameter sets 340 corresponding to at least one other device 110. That is, the central server 100 may perform distance calculations between all participating devices 110.

In step S440, the central server 100 may calculate at least one first weight corresponding to the first device 111 based on the calculated at least one first distance. This step may transform the distances between models into weights, advantageously allowing the implementations of the present disclosure to personalize the models. It should be noted that the method provided may also include calculating at least one second weight corresponding to the second device 112 based on the calculated at least one second distance. That is, the central server 100 may calculate weights corresponding to each participating device 110. For example, based on the calculated at least one K-th distance, it may calculate at least one K-th weight corresponding to the K-th device 110, where K may be the total number of devices 110 participating in federated learning.

In some implementations, the weight calculation process may be more precisely expressed mathematically. If there are K devices 110 in the system, represented by i, j∈{1, 2, . . . , K}. For device i, the distance to device j may be denoted by d(i, j). The weight w(i, j) corresponding to device i may be calculated as follows:

$${w}_{i , j} = \frac{1 / {d}_{i , j}}{{\sum }_{{k ∈ K}_{k \neq i}} 1 / {d}_{i , j}} , if j \neq i else 0$$

where the weight is inversely proportional to the distance, meaning the smaller the distance, the larger the weight; moreover, it may be normalized by dividing by the sum of the reciprocals of all distances, ensuring that the sum of all weights, except for the device itself, equals 1; finally, when i=j, that is, when calculating the weight for the device itself, the weight may be set to zero, ensuring that the device may not directly use its old model parameters during the model updating process. Advantageously, this method of calculating weights may not only effectively transforms the distances between models into weights during the aggregation process but also may ensure the comparability of weights through normalization. Additionally, setting the self-weight to zero may help promote model updating and improvement, avoiding over-reliance on old parameters.

Specifically, the calculation of weights may inversely related to distance, meaning that the smaller the distance between the devices 110, the greater the weight of their mutual influence; conversely, the greater the distance between devices 110, the smaller the weight of their mutual influence. When the central server 100 may calculate the distance of device 110 to itself (i.e., i=j), the corresponding weight in the weight calculation may be set to zero, beneficially ensuring that the old model parameters of the device 110 may not be considered during model updates. This comprehensive method of calculating distance may fully reflect the distribution of models across the entire system, providing a comprehensive basis for subsequent weight calculation and model aggregation. Therefore, for the first device 111, each other device 110 may correspond to a weight w(1,j), and the weight w(1,1) corresponding to the first device 111 itself may not be calculated or may be set to zero; for the second device 112, each other device 110 may correspond to a weight w(2,j), and the weight w(2,2) corresponding to the second device 112 itself may not be calculated or may be set to zero, and so forth.

In some implementations, the weight calculation process may involve calculating the reciprocal of distances. After the central server 100 may calculate the distances between the devices 110, it may take the reciprocal of these distance values as the preliminary weight values, directly reflecting the negative correlation between distance and weight.

In some implementations, to avoid division by zero (for example, when the model parameters of two different devices 110 may be the same), the central server 100 may add a small positive number to the distance values, the present disclosure is not limited thereto. This method may ensure the stability of calculations without affecting the distribution of weights.

In some implementations, the calculated weights may undergo normalization to ensure that the sum of all weights equals 1, facilitating subsequent weighted average operations. For example, the central server 100 may divide each distance's reciprocal, taken as the preliminary weight value, by the sum of all preliminary weight values. Advantageously, the weight calculation method based on the reciprocal of distances and normalization may consider the similarity between devices, ensuring the rationality and effectiveness of weight distribution.

In step S450, the central server 100 may calculate the weighted average of multiple mutual model parameter sets 340 based on at least one calculated first weight to obtain the first mutual model parameter set 341 corresponding to the first device 111. Advantageously, the process of weighted averaging may integrate model information from different devices while also considering personalized weights.

Specifically, taking the first device 111 as an example, after the central server 100 may receive the first mutual model parameter set 341 uploaded by the first device 111, it first may calculate the distances between the first device 111 and all the devices 110 (for example, including the first device 111 itself) and may compute the corresponding weights based on these distances. Then, the central server 100 may multiply the weights of the first device 111 with all devices 110 by their corresponding mutual model parameter sets 340. Finally, by adding these products together, the updated mutual model parameter set 351 corresponding to the first device 111 may be obtained. It should be noted that the method provided in the present disclosure may also include the central server 100 calculating distances after receiving the second mutual model parameter set 342 uploaded by the second device 112, calculating the distances between the second device 112 and all other devices 110, computing corresponding weights, and then multiplying these weights by the mutual model parameter sets 340 of corresponding devices 110, to obtain the updated second mutual model parameter set 352. That is, the central server 100 may perform a similar process for each participating device 110, for each device 110 in the system, the central server 100 may perform the following steps: first calculating distances between all devices 110 (including itself, if applicable), then calculating weights based on those distances, subsequently multiplying these weights with the mutual model parameter sets 340 of all devices 110, and finally adding the products to obtain an updated mutual model parameter set 350.

For example, when there are K devices 110 in the system, where K may be a natural number not less than 2, after the central server 100 may calculate the weights between the first device 111 and each device 110, the central server 100 may multiply the weight (in this case, the weight may be 0) between the first device 111 and the first device 111 by the first mutual model parameter set 341 corresponding to the first device, obtaining product one. Then, he central server 100 may multiply the weight between the first device 111 and the second device 112 by the second mutual model parameter set 342, obtaining product two, and so forth. Subsequently, the central server 100 may multiply the weight between the first device 111 and the K-th device by the mutual model parameter set 340 corresponding to the K-th device, obtaining product K. Finally, the central server 100 may add products one, two, up to K to obtain the updated first mutual model parameter set 351.

Based on the above explanation, as the weights may have been normalized, the method provided in the present disclosure may ensure that when the distance between the first device 111 and any device 110 increases, the influence of the mutual model parameter set 340 of the device 110 on the updated first mutual model parameter set 351 may decrease; conversely, when the distance between the first device 111 and any device 110 decreases, the influence of the mutual model parameter set 340 of the device 110 on the updated first mutual model parameter set 351 may increase. Advantageously, by calculating distances and distributing weights, each device 110 may obtain a model that better suits its characteristics, the implementations of the present disclosure may enhance the personalization of the model. Moreover, by utilizing the learning results of all devices 110, the optimization process of the model may be accelerated, learning efficiency may be enhanced, and by integrating the model information of all devices 110, the ability of the model to handle different situations may be strengthened, improving its generalization capability.

In step S460, the central server 100 may send the calculated updated first mutual model parameter set 351 to the first device 111. It is worth noting that the central server 100 may perform the same process for each participating device 110 before completing a round of model updating to optimize the model of the entire system. That is, the central server 100 may also send the calculated updated second mutual model parameter set 352 to the second device 112, and so forth, until it may send the updated mutual model parameter set 350 corresponding to the K-th device to the K-th device. This method may not only ensures continual improvement of the model but also may maintain the consistency of the system while preserving the characteristics of each device 110.

In step S470, in the next round, the first device 111 may use the first local data 331, the first local model parameter set, and the updated first mutual model parameter set 351 to mutually train the first local model 311 and the mutual model 320. This step may ensure that the model continues to learn and improve. It should be noted that this process may apply not only to the first device 111 but also to other devices in the system (e.g., the second device 112). For example, after the first device 111 may receive the updated first mutual model parameter set 351, it may use it for the next round of local model training. Because the updated first mutual model parameter set 351 may include learning results from the entire system calculated by the central server 100 and weighted based on the distances to other devices 110, this process may enhance the overall performance of the model. That is, using the updated first mutual model parameter set 351 for the next round of training may allow the first device 111 to maintain its characteristics while also benefiting from the data of other devices 110, thus protecting data privacy and effectively sharing information. Similarly, other devices (e.g., the second device 112) that may receive their corresponding updated mutual model parameter set 350 may perform subsequent actions, achieving similarly beneficial effects. In some implementations, the updated mutual model parameter set 350 may replace the mutual model parameter set 340 in the next round of local model training, quickly integrating global knowledge into the local model and accelerating the model's convergence process. In some implementations, the updated mutual model parameter set 350 may be introduced as an additional input in the next round of local model training, preserving the original local knowledge while introducing global information, better balancing local characteristics with global consistency.

The second device 112 may also use the second local data 332 to mutually train the second local model 312 and the mutual model 320, obtaining the second local model parameter set and the second mutual model parameter set 342. Subsequently, the central server 100 may perform the same mutual model training steps, calculating the distances and weights for the second device 112, obtaining the updated second mutual model parameter set 352, and sending it back to the second device 112. This may allow the second device 112 to perform the next round of local model training, and the same may be applied to all K devices 110 participating in federated learning within the system. This method may not only ensure the continuous improvement of the model but also may maintain the consistency of the system while preserving the characteristics of each device 110. The training process of the implementations of the present disclosure may continuously optimize the model through multiple iterations until the predetermined stop conditions are met.

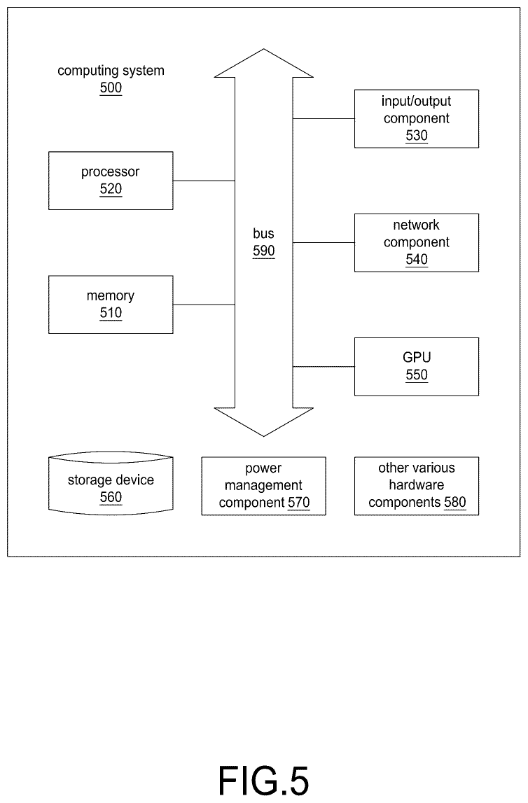

FIG. 5 is a block diagram of a computing system in accordance with an example implementation of the present disclosure

### Model Training Method and System Based on Federated Learning

Referring to FIG. 5, computer-implemented methods such as methods for training a federated learning model introduced in this article, as well as other computer-implemented methods, may be implemented on a computing system 500 with various hardware components. In some implementations, the computing system 500 may be implemented in the form of an electronic device, which may include, but is not limited to, one or more of the following components: processor (e.g., Central Processing Unit (CPU)) 520, Graphics Processing Unit (GPU) 550, input/output components 530, network components 540, and memory 510. These components may communicate and transfer data via the system bus 590. However, the present disclosure does not limit the specific models, quantities, and configurations of these components. Those skilled in the art can adjust, select, or add/subtract components based on the specific requirements and operating environment when implementation.

In some implementations, the primary computing core inside the computing system 500 is one or more processors 520. This processor 520 may be responsible for running the main computational processes and related control logic of algorithms such as deep learning. In some implementations, the processor 520 may be configured to execute processing instructions (e.g., machine/computer-executable instructions) stored in non-volatile computer-readable media (e.g., storage device 560).

In some implementations, to enhance the computational efficiency of federated learning, the computing system 500 may also include one or more graphics processing unis 550 designed for massive parallel computations. The graphics processing unit 550 may effectively improve the system's computational capacity during deep learning training and inference.

In some implementations, the computing system 500 may include various input/output components 530 configured to receive user input and display system output. For example, the input/output components 530 may include a keyboard, mouse, touchpad, display screen, speakers, and other types of sensing devices.

In some implementations, the computing system 500 may also include network components 540 configured for network communication. For example, the network component 540 may include a network interface card for wired or wireless network connections, or communication modules for 3G, 4G, 5G, or other wireless communication technologies.

In some implementations, the computing system 500 may include one or more memory components 510, such as volatile memory components like Random Access Memory (RAM). The memory 510 may store the parameters of the deep learning model, as well as other data and programs used to run algorithms like deep learning.

Furthermore, the computing system 500 may also include one or more of the following components: storage devices 560, power management components 570, and other various hardware components 580.

In some implementations, the computing system 500 may include one or more storage devices 560, such as non-volatile memory components like Hard Disk Drive (HDD) or Solid State Drive (SSD). The storage devices 560 may be configured to store the code of federated learning software, training data, model parameters, etc. Additionally, storage devices 560 may also be configured to store intermediate results and final outputs of algorithms like federated learning.

In some implementations, the computing system 500 may include one or more power management components 570, configured to provide power to various hardware components of the computing system 500 and manage their power consumption. This power management component 570 may include batteries, power converters, and other power management devices.

In some implementations, the computing system 500 may also include other various hardware components 580, such as cooling fans, heat dissipators, and other various control and monitoring devices. The present disclosure is not limited in this regard.

In summary, the model training method and system for federated learning provided in the implementations of the disclosure utilize a weight calculation method based on model distance, effectively address the data privacy issues inherent in traditional centralized machine learning and overcome the drawbacks of model homogenization seen in conventional federated learning. By conducting mutual training of local and mutual models at the device level and integrating a distance-based aggregation strategy at the central server, the disclosure may provide highly personalized and superior performance models for each device while ensuring data privacy. This method may significantly enhance the adaptability and generalization capability of the model while maintaining the overall consistency of the system. Moreover, the method of the present disclosure may be highly scalable and flexible, suitable for various types of machine learning tasks and different system scales, offering a powerful and effective framework for addressing distributed machine learning problems in real-world scenarios.

Based on the above description, it is apparent that various techniques can be configured to implement the concepts described in this application without departing from their scope. Furthermore, although certain implementations have been specifically described and illustrated, those skilled in the art will recognize that variations and modifications can be made in form and detail without departing from the scope of the concepts. Thus, the described implementations are to be considered in all respects as illustrative and not restrictive. Moreover, it should be understood that this application is not limited to the specific implementations described above, but many rearrangements, modifications, and substitutions can be made within the scope of the present disclosure.

What is claimed is:

1. A method for implementing model training, based on federated learning, applicable to a central server, the method comprising:
receiving a plurality of first model parameter sets correspondingly from a plurality of devices;
calculating at least one first distance between one set of the plurality of first model parameter sets corresponding to a first device, among the plurality of devices, and at least one other set of the plurality of first model parameter sets corresponding to at least one other device, different from the first device, among the plurality of devices;
calculating at least one first weight corresponding to the first device based on the at least one first distance;
calculating a first weighted average of the plurality of first model parameter sets, based on the at least one first weight, to obtain a second model parameter set corresponding to the first device; and
sending the second model parameter set corresponding to the first device to the first device.

2. The method of claim 1, further comprising:
calculating at least one second distance between one set of the plurality of first model parameter sets corresponding to a second device, among the plurality of devices, and at least one other set of the plurality of first model parameter sets corresponding to at least one other device, different from the second device, among the plurality of devices;
calculating at least one second weight corresponding to the second device based on the at least one second distance;
calculating a second weighted average of the plurality of first model parameter sets, based on the at least one second weight, to obtain a second model parameter set corresponding to the second device; and
sending the second model parameter set corresponding to the second device to the second device.

3. The method of claim 1, further comprising:
receiving a plurality of second model parameter sets correspondingly from the plurality of devices, the plurality of second model parameter sets comprising one set of the plurality of second model parameter sets corresponding to the first device and at least one other set of the plurality of second model parameter sets corresponding to the at least one other device, different from the first device, among the plurality of devices;
calculating at least one second distance between the one set of the plurality of second model parameter sets corresponding to the first device and the at least one other set of the plurality of second model parameter sets corresponding to the at least one other device, different from the first device, among the plurality of devices;
calculating at least one second weight corresponding to the first device based on the at least one second distance;
calculating a weighted average of the plurality of second model parameter sets, based on the at least one second weight, to obtain a third model parameter set corresponding to the first device; and
sending the third model parameter set to the first device.

4. The method of claim 1, wherein the at least one first distance comprises at least one of a Euclidean distance, a cosine similarity, and a Manhattan distance.

5. The method of claim 1, wherein calculating the at least one first weight corresponding to the first device based on the at least one first distance comprises:
calculating at least one reciprocal of the at least one first distance; and
normalizing the at least one reciprocal to obtain the at least one first weight.

6. The method of claim 1, wherein the at least one first weight is negatively correlated with the at least one first distance.

7. A method for implementing model training, based on federated learning, applicable to a system comprising a plurality of devices and a central server, the method comprising:
in a current round:
a first device, among the plurality of devices, obtaining, by using first local data to mutually train a first local model and a mutual model, a first local model parameter set and a first mutual model parameter set; and
the central server:
receiving a plurality of mutual model parameter sets from the plurality of devices, the plurality of mutual model parameter sets comprising the first mutual model parameter set,
calculating at least one first distance between the first mutual model parameter set corresponding to the first device and at least one set of the plurality of mutual model parameter sets corresponding to at least one other device, different from the first device, among the plurality of devices,
calculating at least one first weight corresponding to the first device based on the at least one first distance,
calculating a weighted average of the plurality of mutual model parameter sets based on the at least one first weight to update the first mutual model parameter set corresponding to the first device, and
sending the first mutual model parameter set that is updated to the first device; and
in a next round, the first device using the first local data, the first local model parameter set, and the first mutual model parameter set that is updated to mutually train the first local model and the mutual model.

8. The method of claim 7, further comprising:
in the current round:
a second device, among the plurality of devices, obtaining, by using second local data to mutually train a second local model and the mutual model, a second local model parameter set and a second mutual model parameter set; and
the central server further:
receiving the plurality of mutual model parameter sets from the plurality of devices, the plurality of mutual model parameter sets further comprising the second mutual model parameter set,
calculating at least one second distance between the second mutual model parameter set corresponding to the second device and at least one other set of the plurality of mutual model parameter sets corresponding to at least one other device, different from the second device, among the plurality of devices,
calculating at least one second weight corresponding to the second device based on the at least one second distance, and
calculating a weighted average of the plurality of mutual model parameter sets based on the at least one second weight to update the second mutual model parameter set corresponding to the second device; and
in the next round, the second device using the second local data, the second local model parameter set, and the second mutual model parameter set that is updated to mutually train the second local model and the mutual model.

9. The method of claim 7, wherein the first device, among the plurality of devices, using the first local data to mutually train the first local model and the mutual model comprises:
calculating a difference measure between the first local model and the mutual model; and
updating the first local model and the mutual model based on the difference measure.

10. A central server, comprising:
a memory configured for storing at least one instruction; and
a processor coupled to the memory, wherein when the processor executes the at least one instruction, the central server is configured to:
receive a plurality of first model parameter sets correspondingly from a plurality of devices;
calculate at least one first distance between one set of the plurality of first model parameter sets corresponding to a first device, among the plurality of devices, and at least one other set of the plurality of first model parameter sets corresponding to at least one other device, different from the first device, among the plurality of devices;
calculate at least one first weight corresponding to the first device based on the at least one first distance;
calculate a first weighted average of the plurality of first model parameter sets, based on the at least one first weight, to obtain a second model parameter set corresponding to the first device; and
send the second model parameter set corresponding to the first device to the first device.

11. The central server of claim 10, when the processor executes the at least one instruction, the central server is further configured to:
calculate at least one second distance between one set of the plurality of first model parameter sets corresponding to a second device, among the plurality of devices, and at least one other set of the plurality of first model parameter sets corresponding to at least one other device, different from the second device, among the plurality of devices;
calculate at least one second weight corresponding to the second device based on the at least one second distance;
calculate a second weighted average of the plurality of first model parameter sets, based on the at least one second weight, to obtain a second model parameter set corresponding to the second device; and
send the second model parameter set corresponding to the second device to the second device.

12. The central server of claim 10, when the processor executes the at least one instruction, the central server is further configured to:
receive a plurality of second model parameter sets correspondingly from the plurality of devices, the plurality of second model parameter sets comprising one set of the plurality of second model parameter sets corresponding to the first device and at least one other set of the plurality of second model parameter sets corresponding to the at least one other device, different from the first device, among the plurality of devices;
calculate at least one second distance between the one set of the plurality of second model parameter sets corresponding to the first device and the at least one other set of the plurality of second model parameter sets corresponding to the at least one other device, different from the first device, among the plurality of devices;
calculate at least one second weight corresponding to the first device based on the at least one second distance;
calculate a weighted average of the plurality of second model parameter sets, based on the at least one second weight, to obtain a third model parameter set corresponding to the first device; and
send the third model parameter set to the first device.

13. The central server of claim 10, wherein the at least one first distance comprises at least one of a Euclidean distance, a cosine similarity, and a Manhattan distance.

14. The central server of claim 10, wherein calculating the at least one first weight corresponding to the first device based on the at least one first distance comprises:
calculating at least one reciprocal of the at least one first distance; and
normalizing the at least one reciprocal to obtain the at least one first weight.

15. The central server of claim 10, wherein the at least one first weight is negatively correlated with the at least one first distance.
